(19) United States
(12) Patent Application Publication
(10) Pub. No.: US 2026/0329631 A1
(43) Pub. Date: Oct. 22, 2026

(54) TASK-ORIENTED EMBEDDING DISTORTION MODEL FOR ORCHESTRATION PLANNING

(71) Applicant: Dell Products L.P., Round Rock, TX (US)

(72) Inventors: Eduardo Vera Sousa, Niteroi (BR); Karen Stéfany Martins Zuin, Belo Horizonte (BR)

(21) Appl. No.: 19/186,488

(22) Filed: Apr. 22, 2025

(51) Int. Cl. G06F 9/48; G06F 18/241

(52) U.S. Cl. CPC G06F 9/4881; G06F 18/241

(57) ABSTRACT

One example method involves facilitating the orchestration of tasks that are based on user inputs provided to an LLM (large language model), by performing operations including receiving, by an embedding space transformation module, respective inputs from a first user and a second user, creating, by the embedding space transformation module, respective embedding vectors for each of the inputs, by the embedding space transformation module, transforming the embedding vectors into respective transformed embedding vectors, performing, by a cosine similarity function, a comparison of the transformed embedding vectors, outputting, by the cosine similarity function, a similarity score based on the comparison that indicates an extent to which the inputs are similar to each other and, calling, by an orchestrator, one or more tasks whose type and number are determined based in part on the similarity score.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to task orchestrators and associated methods. More particularly, at least some embodiments relate to systems, hardware, software, architectures, computer-readable media, and methods, for a task-oriented embedding distortion model for orchestration planning.

### BACKGROUND

Agents are able to accomplish tasks through self-directed planning and actions. It is considered a promising approach to achieve general intelligence (AGI). Agents can be divided into four main modules, namely, profile, memory, planning and action. The profile module is responsible for attribute a specific role for the agent, such as a teacher or a lawyer for example. The memory stores important information from previous interactions to improve future behavior of the agent. The planning module receives a task and breaks it in smaller subtasks based on the available tools. Finally, the action module executes the plan to accomplish the task. With the advancement of LLMs (large language models), it has proven to be an important component of agents, specially to plan the actions to be taken.

An important step of the planning phase is to identify which task was mentioned in the user query. Recent approaches are based on LLMs, although these approaches, like zero-shot classifiers, are prone to hallucination as the number of tasks increases, thus affecting the reliability of the LLM. As well, LLMs generally have high computational cost when compared to other approaches, sometimes demanding specific hardware in order to run in a feasible amount of time. In a simpler solution, given a user query, a user might select samples from each available task, apply an embedder model to the samples and the query, and calculate the similarity between the user query and each sample, and then selecting the task with highest score. However, if a sample and a query refers to the same task but describe it in a completely different manner, the similarity score will not work.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

It is noted that color versions of FIGS. 1 through 11 are included in the Appendix A hereto which is incorporated herein in its entirety by this reference.

FIG. 1 discloses examples of pairs of vectors in an Euclidean Space and how the cosine similarity changes depending on the angle between them.

FIG. 2 discloses a representation of a pair of vectors (u and v) in a Euclidean Space.

FIG. 3 discloses a neural network (NN) employed in a method, according to one embodiment.

FIG. 4 discloses a neural network training process, where both modules ƒ and g are trained simultaneously, according to one embodiment.

FIG. 5 discloses a usage process of a trained Embedding Transformation Module, according to one embodiment.

FIG. 6 discloses a graph of a number of samples per task in a filtered dataset.

FIG. 7 discloses cosine similarity using all-minilm (original distribution) and the proposed solution (transformed distribution) for samples in the same class (values closer to 1 are better), according to one embodiment.

FIG. 8 discloses cosine similarity using all-minilm (original distribution) and the proposed solution (transformed distribution) for samples in different classes (values closer to 0 are better), according to one embodiment.

FIG. 9 discloses confusion matrices summarizing the results of applying bart-large-mnli zero-shot classifier in a test set, according to one embodiment.

FIG. 10 discloses a confusion matrix applying an embodiment as classifier in a test set.

FIG. 11 discloses an embedding visualization for the original (the left figure) and transformed space (center figure) and a zoomed-in version of the center figure, according to one embodiment.

FIG. 12 discloses a computing entity configured and operable to perform any of the disclosed methods, processes, and operations.

### DETAILED DESCRIPTION OF SOME EXAMPLE EMBODIMENTS

Embodiments disclosed herein generally relate to task orchestrators and associated methods. More particularly, at least some embodiments relate to systems, hardware, software, architectures, computer-readable media, and methods, for a task-oriented embedding distortion model for orchestration planning.

Example embodiments are directed to, among other things, a neural network that comprises an embedding space transformation module and a classification module, a method for training the neural network, a method for using the neural network to perform inferencing, and a method for creating and using an embedding transformation module. In one particular example embodiment, a method for using a trained embedding transformation module comprises operations including, but not limited to: receiving, by a trained embedding module, respective inputs from a user A and a user B; creating, by the trained embedding module, respective embedding vectors for each of the inputs; by an embedding transformation module, transforming the embedding vectors into respective transformed embedding vectors; performing, by a cosine similarity function, a comparison of the transformed embedding vectors; and, outputting, by the cosine similarity function, a similarity score based on the comparison.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect is that an embodiment may employ a neural network classifier to adapt an embedding space, or latent space, of a neural network. An embodiment may employ a cosine similarity metric for performing comparisons according to a given criterion. An embodiment may define and implement a task-oriented embedding space that identifies a similarity between tasks, and which may be used in orchestration decisions. Various other advantages of one or more example embodiments will be apparent from this disclosure.

### A. REFERENCES

Reference is made herein to various documents. These documents are listed below and are incorporated herein in their respective entireties by this reference.
[1] Wang, Lei, et al., A survey on large language model based autonomous agents., arXiv preprint arXiv:2308.11432, 2023.
[2] Wang, Wenhui, et al., Minilm: Deep self-attention distillation for task-agnostic compression of pre-trained transformers., Advances in Neural Information Processing Systems 33, 2020.
[3] Fernandes, Leandro Augusto Frata, Carlile Lavor, and M. M. O. Neto., Álgebra geometrica e aplicações (in Portuguese), Notas em Matemática Aplicada. SBMAC, 2017.
[4] Guy Lebanon, “Guy Lebanon's Website,” [Online]. Available: http://theanalysisofdata.com/probability/B_4.html.
[5] Tom Dalling, “Tom Dalling's Blog,” [Online]. Available: https://www.tomdalling.com/blog/modern-opengl/explaining-homogenous-coordinates-and-projective-geometry/.
[6] Sousa, Eduardo V. and Fernandes, Leandro A. F. and Vasconcelos, Cristina N., “ConformalLayers: a non-linear sequential neural network with associative layers,” 2021.
[7] Shen, Yongliang, et al., Taskbench: Benchmarking large language models for task automation, arXiv preprint arXiv:2311.18760, 2023.
[8] Lewis, M., Bart: Denoising sequence-to-sequence pre-training for natural language generation, translation, and comprehension, arXiv preprint arXiv:1910.13461, 2019.

### B. ASPECTS OF AN EXAMPLE CONTEXT AND CONSIDERATIONS FOR ONE EMBODIMENT

The following is a discussion of aspects of example context and considerations for various embodiments. This discussion is not intended to limit the scope of the claims or this disclosure, or the applicability of the embodiments, in any way.

As noted above, an important step of a planning phase implemented by an agent that is able to accomplish tasks through self-directed planning and actions is to identify which task was mentioned in a user query provided to the agent. Some approaches are based on LLMs but are prone to hallucination as the number of tasks increases, affecting the reliability. Moreover, LLMs generally have high computational costs. In a simple approach, given a user query, an approach may select samples from each available task, apply an embedder model to the samples and the query, and calculate the similarity between the user query and each sample, selecting the task with highest score. However, if a sample and a query both refer to the same task, but describe it in a completely different manner, the similarity score would not work. As an example, consider the following two user inputs:
1) Please summarize the text: “Large Language Models (LLMs) are advanced artificial intelligence systems designed to understand and generate human-like text based on vast amounts of data. These models, such as GPT-4, are trained on diverse datasets, enabling them to perform a wide range of tasks, from answering questions and translating languages to creating content and summarizing information. LLMs leverage deep learning techniques, particularly neural networks, to predict and generate coherent and contextually relevant text. Their applications span various fields, including customer service, education, and content creation, making them powerful tools for enhancing productivity and communication.” (example text generated by Microsoft Copilot)
2) I have the following text about orange cats that must be summarized into bullet points for a presentation: “Orange cats, often referred to as ginger or marmalade cats, are known for their striking coat color and charming personalities. These cats can be found in various breeds, including the popular domestic shorthair and longhair. Their vibrant fur is due to a genetic mutation that produces a high level of pheomelanin, the pigment responsible for red and orange hues. Orange cats are often associated with friendly and affectionate behavior, making them beloved companions. They also tend to have distinct tabby patterns, which can range from classic swirls to mackerel stripes, adding to their unique and endearing appearance.” (example text generated by Microsoft Copilot)

It is noted that an agent planning for both user inputs should call the same task, namely, “summarization.” Due to the differing nature of the user inputs, however, their cosine similarity is small (approximately 0.00024) considering the embedding model all-minilm (see [2]) an embedding model in Hugging Face. On the other hand, consider the following user inputs:
1) I need a summarization of how a motor works, considering the following context: “A motor works by converting electrical energy into mechanical energy. Inside the motor, an electric current flow through a coil of wire, creating a magnetic field. This magnetic field interacts with the magnets inside the motor, causing the coil to rotate. The rotation of the coil is transferred to a shaft, which then drives the mechanical components of the device the motor is powering. This process allows the motor to perform tasks such as turning the wheels of a car or running a household appliance.” (example text generated by Microsoft Copilot)
2) Considering the context below, please generate a schematic figure of how a motor works: “A motor works by converting electrical energy into mechanical energy. Inside the motor, an electric current flow through a coil of wire, creating a magnetic field. This magnetic field interacts with the magnets inside the motor, causing the coil to rotate. The rotation of the coil is transferred to a shaft, which then drives the mechanical components of the device the motor is powering. This process allows the motor to perform tasks such as turning the wheels of a car or running a household appliance.” (example text generated by Microsoft Copilot)

This last example would be common in the context of RAGs, for example, that return similar sources. In this scenario, both user inputs produce high cosine similarity (approximately 0.95) even when the orchestrator clearly should have called different tasks, namely: “summarization” (example 1)) and “image generation” (example 2)).

With this context, an embodiment comprises the definition and use of an embedding space distortion model based on the tasks. An embodiment of the distortion model enables a comparison to be performed to determine if two inputs are from different tasks, even if both contexts are similar or, on the other hand, if two inputs are from the same task even if the contexts are completely different. Additionally, an embodiment may avoid the need for the retraining of the model that generates the embeddings.

### C. OVER VIEW OF ASPECTS OF ONE OR MORE EMBODIMENTS

### C.1 Introduction

An embodiment comprises an embedding space distortion model to improve the similarity metric between a pair of inputs with respect to the task call that must be planned by an orchestrator. Such distortion model enables mapping of the embedding space into a task-oriented space in order to apply similarity metrics.

One embodiment may rely on a generalization of the inner product, which is part of the cosine similarity calculation, to redefine the metric space. This redefinition is performed by replacing the Metric matrix by a specific (and low-cost) neural network. This enables distortion of the trained embedding space so that it becomes able to approximate vectors that are linked to the same task while it increases the distance of vectors linked to different tasks.

By defining each task as a class, an embodiment is able to train a classifier called metric neural network to receive a user input and estimate the class where it belongs to. The architecture of this neural network is defined in a way that, once trained, an embodiment may ignore the last layers and use the network to map from the original embedding space to the task-oriented space while keeping the same dimensionality. By using this architecture, an embodiment is able to apply cosine similarity as usual to compare the similarity between a pair of inputs.

### C.2 Discussion

One or more example embodiments comprise an embedding space distortion model to improve the similarity metric between a pair of inputs with respect to the task call that must be planned by an orchestrator. Such distortion model enables mapping the embedding space into a task-oriented space in order to apply similarity metrics.

One embodiment may rely on a generalization of the inner product, which is part of the cosine similarity calculation, to redefine the metric space. See [3]. This redefinition is performed by replacing the Metric matrix by a specific, and low-cost, neural network. This enables a distortion the trained embedding space so that becomes able to approximate vectors that are linked to the same task while it increases the distance of vectors linked to different tasks.

By defining each task as a class, an embodiment may be able to train a classifier referred to as a Metric Neural Network (MNN) to receive a user input and estimate the class to which that input belongs. The architecture of this neural network is defined in a way that, once trained, the last layers may be ignored, and the network used to map from the original embedding space to the task-oriented space while keeping the same dimensionality. By using this architecture, an embodiment may be able to apply cosine similarity as usual to compare the similarity between a pair of inputs.

As disclosed herein, one or more embodiments may comprise various useful features and aspects, although no embodiment is required to possess any of such features or aspects. The following examples are illustrative, but not exhaustive.

An embodiment may provide for usage of a neural network classifier to adapt the embedding space. Particularly, an embodiment may leverage the classifier architecture to adapt the latent space of a neural network by using a specifically designed architecture.

An embodiment may employ provide for adaptation of a cosine similarity metric for comparisons accordingly to a given criterion. As demonstrated in the problem description above, the cosine similarity does not work natively when a criterion, which may be task-based, is applied. One or more embodiments may thus distort the space accordingly to this criterion in order to enable the usage of cosine similarity as metric.

An embodiment may provide a task-oriented embedding space for similarity in orchestration planning. As disclosed herein, experiments show that, by using the Metric Neural Network in the inner product generalization, an embodiment may be able to identify inputs from the same tasks even if the descriptions are different, or to identify if the inputs are from different tasks even if the descriptions are similar.

### D. DETAILED DISCUSSION

### D.1 Background

D.1.1 cosine similarity

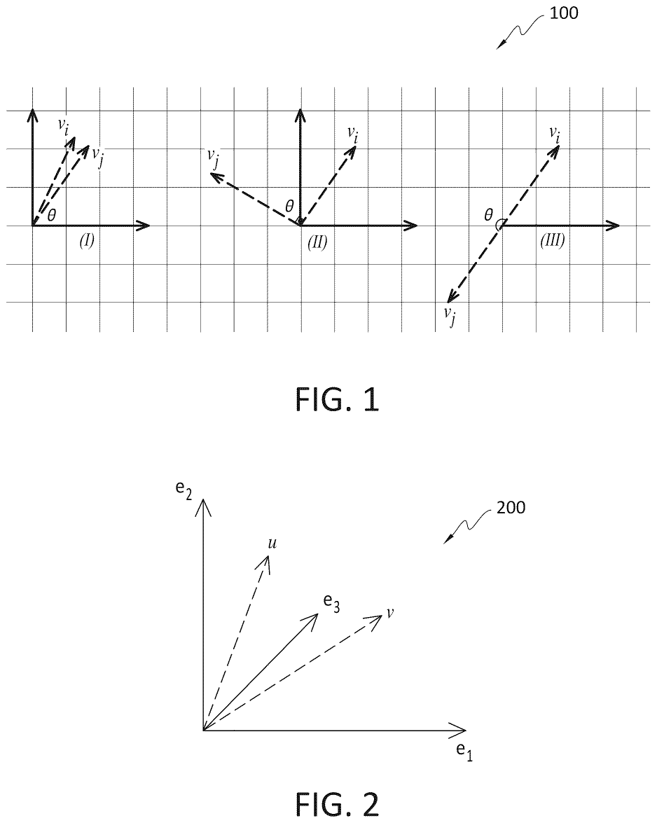

Cosine similarity is a metric used to compare a pair of vectors in [symbol] ⁿ. With reference to the example graphs 100 of FIG. 1, cosine similarity is based on the idea that, if a pair of vectors is similar as shown in FIG. 1 (part I), the angle θ between a pair of vectors is close to zero (which implies in cos θ≅1). If the vectors are not similar, for instance, and are orthogonal, as depicted in FIG. 1 (part II), the cosine of the angle θ between them is zero. Finally, if the vectors have the same attitude, that is, they have the same baseline, as depicted in FIG. 1 (part III), but opposite directions (i.e. θ=180°), the cosine is −1.

The cosine similarity S_{c} can be seen as a normalized inner product between a pair of vectors, as shown by the middle term below, embedded in a Euclidean Space or as the inner product between a pair of normalized vectors, as shown in the right term below, in the same space. Formally:

$${S}_{c} ( u , v ) = \frac{u \cdot v}{‖ u ‖ ‖ v ‖} = \frac{u}{‖ u ‖} \cdot \frac{v}{‖ v ‖}$$

where ∥u∥ and ∥v∥ denotes the [symbol] ²-norm the vectors u and v, and (u. v) denotes the inner product operation. Let x be a n-dimensional vector given by:

$$x = [ \begin{matrix}{x}_{1} \\ {x}_{2} \\ ⋮ \\ {x}_{n}\end{matrix} ]$$

its [symbol] ²-norm is then given by:

$$‖ x ‖ = \sqrt{{x}_{1}^{2} + {x}_{2}^{2} + ⋯ + {x}_{n}^{2}} = \sqrt{{\sum }_{i = 1}^{n} {x}_{i}^{2}}$$

### D.1.2 the Generalization of Inner Product for Non-Euclidean Metrics

A metric operation, like the inner product, is formally defined as an operation that depends on the metric adopted by the space where the vectors are embedded. In linear algebra, a Euclidean metric space is traditionally used (see [4]), where all the basis vectors are orthonormalized or homogeneous (or projective) metric space (see [5]) for most applications in computer science. It is noted that while the first is a default framework adopted by some neural networks, despite some works changes this to other metric spaces, (as in [6]), the latter is more commonly used in computer graphics.

The inner product is used to compute the angle between a pair of vectors. Let u and v be a pair of vectors thus:

$$[ \begin{matrix}{u}_{1} \\ {u}_{2} \\ ⋮ \\ {u}_{n}\end{matrix} ] and v = [ \begin{matrix}{v}_{1} \\ {v}_{2} \\ ⋮ \\ {v}_{n}\end{matrix} ]$$

in [symbol] ⁿ (i.e., under Euclidean Metric Space). In this scenario, the inner product X is given by

$$X = u . v = ‖ u ‖ ‖ v ‖ cos θ = {\sum }_{i = 1}^{n} {u}_{i} {v}_{i}$$

It is noted, however, that this operation does not generalize for other (non-Euclidean) Metric Spaces. The generalization of this operation for any metric space is given by:

X=uMv^{T}

where M is the metric space matrix. This matrix describes how the basis vectors relate to each other. An interesting observation regarding the specialization for the Euclidean space is that the metric for a Euclidean space is an identity matrix, as each column of the metric matrix has [symbol] ²-norm equals 1 and is orthogonal w.r.t. the other columns. As an example, here is the metric matrix for a 3-D Euclidean space:

$$\begin{matrix} & {e}_{1} & {e}_{2} & {e}_{3} \\ {e}_{1} & 1 & 0 & 0 \\ {e}_{2} & 0 & 1 & 0 \\ {e}_{3} & 0 & 0 & 1\end{matrix}$$

where e₁, e₂ and e₃ are the basis vectors that expands this space, as depicted in the example graph 200 of FIG. 2.

The relation between the general and the specialized form of the inner product in a d-dimensional Euclidean space is given by:

$$X = u {Mv}^{T} = {[ \begin{matrix}1 & 0 & ⋯ & 0 \\ 0 & 1 & ⋱ & 0 \\ ⋮ & ⋮ & ⋱ & ⋮ \\ 0 & 0 & ⋯ & 1\end{matrix} ] [ {v}_{1} , {v}_{2} , , {v}_{d} ]}^{T} = {\sum }_{i = 1}^{n} {u}_{i} {v}_{i}$$

An important aspect of one or more embodiments relies on the fact that the neural network models are deeply entangled with linear algebra and are embedded in the Euclidean Space. In practical terms, it may be safe to assume that neural network models—including LLMs, embedding models, and convolutional neural networks (CNN)—commonly use an implicit Euclidean metric.

### D.2 Discussion

One or more example embodiments comprise a method to change the metric space where an embedding vector was trained. In practical terms, this enables adjustments to the semantics of the embedding according to a user-defined criterion.

While the detailed experimentation presented elsewhere herein refers to task selection in the context of agent orchestration, the disclosed methods also have applications in Retrieved Augmented Generation (RAG), as such methods may improve the similarity between sources accordingly to user-defined criteria. Additionally, when used in association with out-of-distribution detection in classifiers, this approach can also be useful in the context of content moderation. Finally, this method is able to deliver competitive results when compared to an LLM fine-tuning but with smaller computational cost.

The equations described in earlier may be considered as a plain “vanilla” approach for handling the inner product in general metric spaces. One or more of the disclosed embodiments are slightly different from that, and tend to focus not so much on the matrix M itself, although it could be derived. Instead, in some embodiments this metric is learned and embedded in the weights of a specific module inside a neural network classifier, interpreted as a function ƒ. The following discussion provides further information about this.

### D.2.1 Neural Network for Similarity Definition

One or more embodiments may employ a multi-layer perceptron, or neural network, for classification tasks. In practice, other methods that improve the separability between samples, such as regression for example, could be used. Some embodiments employ a classifier because the separability comes from the class definition.

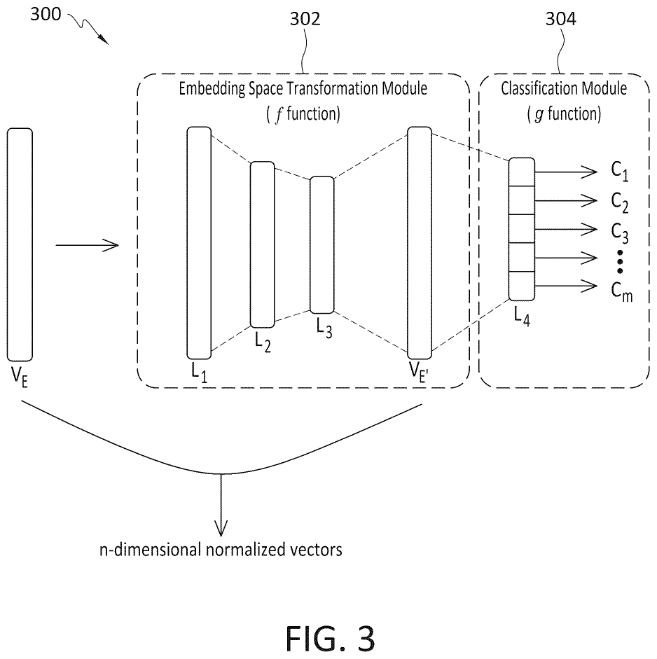

With regards to its architecture, and with reference now to FIG. 3, an architecture 300 of a neural network may, in one embodiment, comprise two elements: (i) an embedding space transformation module 302 and (ii) a classification module 304. It is noted that while both of these elements are used during a training process according to one embodiment, only the embedding space transformation module 302 is used in the embedding space mapping process once the neural network weights have been learned. In this architecture 300, there is a vector in the embedding space E, represented by v_{E}, used as input for the neural network. The embedding space E, in this embodiment, comes from a pretrained embedding model, namely, all-minilm (see [2]) in this example. The layers L₁ and L₂ correspond to fully connected layers, each one followed by a function used as activation (ReLU was used in the experiments described below). The last layer of the embedding transformation module 302 (L₃, in this example) outputs a vector in a different embedding space E′, here represented by v_{E}r. This last layer has two constraints:
(i) Its output has the same dimensionality of the input v_{E}, so the information is mapped to a different metric (embedding space) but kept in the same dimensionality; and
(ii) its output is normalized under the [symbol] ²-norm, which guarantees no “energy” is added to or removed from the original signal, that is, no information is added to, or lost from, the original input, which is also normalized.

With continued reference to the architecture 300, the classification module 304 receives the n-dimensional vector v_{E′} and classifies it using a fully connected layer L₄. In the experiments described herein, this last layer L₄ was attached to a softmax function, just to keep the idea of probability.

It is noted that in an embodiment, both modules are trained simultaneously, i.e., the weights of both the embedding space transformation module 302 and the classification module 304 are updated in the same backpropagation step, which ensures dependability between the modules in the learning process, that is, the embedding space mapping depends on the classification criteria.

At inference time, on the other hand, the embedding space transformation module 302 can work independently from the classification module 304 so that, depending on the application, the classification module 304 may not be needed. it may be useful, however, to retain the classification module 304 for the purposes of analysis, to compare with other approaches, such as a zero-shot classifier, for example, especially on the aspect of scalability on the number of classes.

With continued reference to the example architecture 300 of FIG. 3, there is discloses a neural network adopted in this embodiment of a method. As shown, the embedding space transformation module 302 maps the input v_{E} to v_{E′}, both normalized and with the same dimensionality, and the classification module 304 that classifies v_{E′} accordingly to a user-defined criterion. In the training phase, both modules are connected. in the inference phase, the classification module 304 may be discarded, as the particular focus turns to the embedding space transformation implemented by the embedding space transformation module 302.

Following is a discussion of mathematical formalization relating to the architecture 300. Particularly, in the training phase, while the backpropagation ensures that the separability of the classes using the classification module, the update of the weights of the embedding space transformation module 302 ensures a transformation to a metric space that leads to that separability. Let ƒ and g be functions that corresponds to, respectively, the embedding space transformation module 302 and the classification module 304 of the neural network. The function ƒ that maps a vector embedding space into another with a different metric and same dimensionality. Thus, ƒ is a function:

ƒ: [symbol] ⁿ→ [symbol] ⁿ

while g is a function:

g: [symbol] ⁿ→ [symbol] ^{|C|}

where |C| corresponds to the number of possible classes. Let v_{E} be the vector in an embedding space previously trained by an LLM model to be used as input of our neural network. In the embedding transformation module 302, an embodiment has:

v_{E′}=ƒ(v_{E})

that is used as input for the in the classification module 304:

ŷ=g(v_{E′}),

where ŷ is the predicted class which the vector v_{E} belongs to. In practical terms, the training is performed, in this embodiment of the invention disclosure, by minimizing the cross-entropy loss, that is, the classification error, of:

ŷ=g(ƒ(v_{E})).

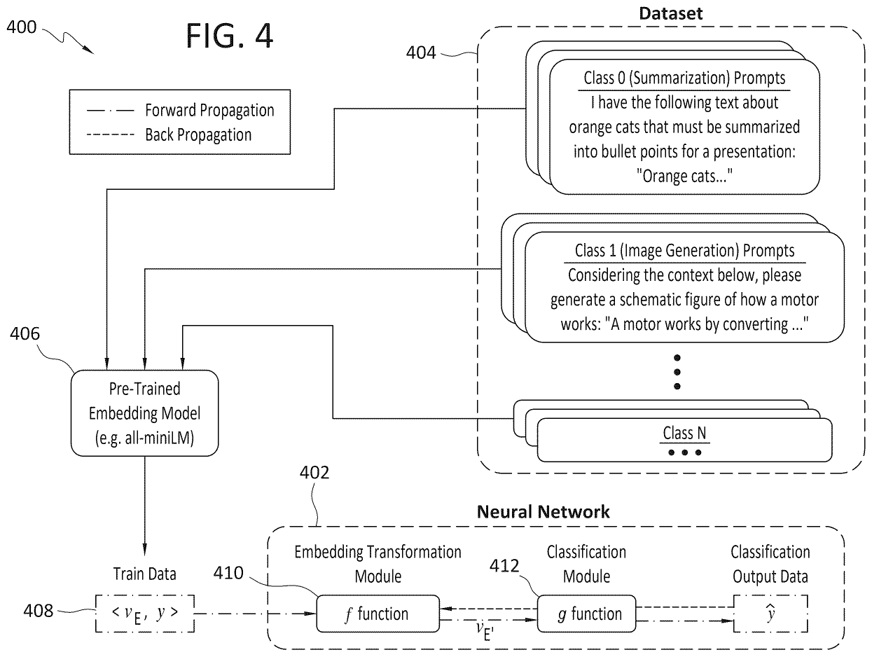

For the embedding space mapping task, however, the class is no longer of interest, and the focus is only on the representation of v_{E} in this new embedding space E′, that is, using ƒ to obtain v_{E′}. FIG. 4 discloses an example pipeline 400 for a neural network 402 training process according to one embodiment in which both modules ƒ and g are trained simultaneously. In this example, a set 404 of labeled prompts, that is, LLM prompts, is provided, where each label corresponds to a possible task the prompt refers to, that is, the class. One embodiment may use a pre-trained embedding model 406 to extract the embedding from each prompt of the set 404.

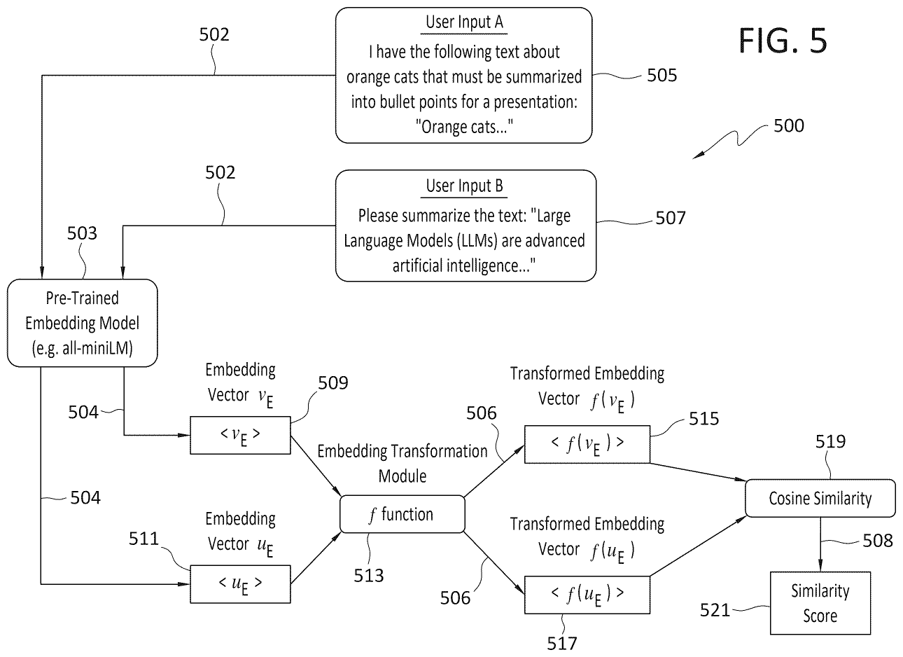

Each one of those embeddings, associated with the respective class (task) it belongs to, forms a training dataset 408. An embodiment uses data of the training dataset 408 to train the neural network 402 that comprises the embedding space transformation module 410 and the classification module 412. Once the training is completed, the function ƒ (and g, if needed) is ready to be used in an embedding space mapping process, described below in connection with FIG. 5 which, in brief, discloses an example process for using the trained embedding transformation module, where both inputs to the cosine similarity are first transformed into this new embedding space so that the cosine similarity describes better the data similarity intra-class and inter-class.

With regard to an application of an approach according to one embodiment, recall the example of the cosine similarity between the pair of vectors u and v. Once the neural network is properly trained, both the embedding space transformation and classification modules can be detached from each other. The interpretation of the function modeled by the neural network is that the first module makes the similar data closer in the new embedding space while increasing the distance between different data, where “similar” and “different” are concepts based on the criterion adopted in the classification. In this embodiment, “similar” corresponds to inputs related to the same task and “different” refers to the opposite. The classification module then applies a transformation on this data and enables an estimation of the class that each one of those transformed vectors belongs to. It is noted that this may be achieved without relying on the generalization discussed in the section above concerning generalization of inner product for non-Euclidean metrics. In practice, the metric matrix M may be encoded in the weights of the function ƒ.

With reference now to the particular example of FIG. 5, a method 500 according to one embodiment is disclosed. The method 500 may comprise the use of a trained embedding transformation module to perform various operations. The method 500 may begin with the receipt 502, by a trained embedding module 503, respective inputs 505 and 507 from a user A and a user B. Next, the method 500 may include creating 504, by the trained embedding module 503, respective embedding vectors 509 and 511 for each of the inputs. An embedding transformation module 513, may then transform 506 the embedding vectors into respective transformed embedding vectors 515 and 517. Next, a cosine similarity function 519 may be used to perform a comparison of the transformed embedding vectors, and the cosine similarity function 519 may then output 508 a similarity score 521 resulting from the comparison.

With continued reference to the example of FIG. 5, it is possible to estimate the weights of the function ƒ and present those in the form (u M v^{T}) but this does not provide any computational advantage so may be ignored. As noted above, FIG. 5 discloses an example process of using the embedding transformation module, that is, the function ƒ, to compute the cosine similarity in this now transformed embedding space. Recall the cosine similarity function presented earlier herein:

$${S}_{c} ( u , v ) = \frac{u}{‖ u ‖} \cdot \frac{v}{‖ v ‖}$$

Now consider also the function ƒ as an argument to the computation of S_{c}:

$${S}_{c} ( {u}_{E} , {v}_{E} , f ) = \frac{f ( {u}_{E} )}{‖ f ( {u}_{E} ) ‖} \cdot \frac{f ( {v}_{E} )}{‖ f ( {v}_{E} ) ‖} = f ( {u}_{E} ) \cdot f ( {v}_{E} ) = {u}_{{E}^{′}} \cdot {v}_{{E}^{′}}$$

It is noted that, because of the normalization performed in the output layer of the embedding transformation module, the [symbol] ²-norm became 1, so the cosine similarity is reduced to the inner product between the transformed embeddings.

### E. EXAMPLE EXPERIMENT AND RESULTS

To evaluate an embodiments, the inventors created a Jupyter Notebook (see Appendix B, which is incorporated herein in its entirety by this reference) with the goal of training a model to classify the task associated to a given user input. A class, in the context of this ID, is a task description. Examples include:
Class 1: (‘Audio-to-Audio’)
Class 2: (‘Summarization’)
Class 3: (‘Automatic Speech Recognition’)

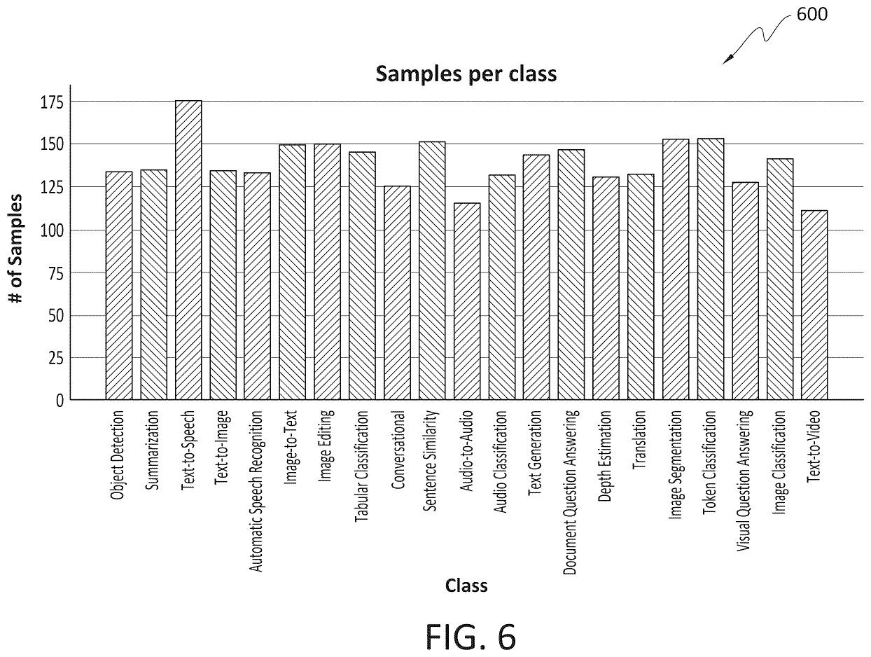

The inventors used the TaskBench dataset (see [7]), which is a benchmark for evaluating large language models (LLMs) on task automation. The benchmark contains an instruction (e.g., “I've got an image named ‘example.jpg’ and I'm curious about the predominant color. Can you figure it out for me?”) and the tasks needed to execute it (e.g., “Visual Question Answering”). To create a fair evaluation between the classes, the inventors filtered the dataset to keep only classes with at least one hundred samples. After filtering the data, only instructions with one task remained, as shown in the table 600 disclosed in FIG. 6 which shows the number of samples per task in the filtered dataset. In addition, the inventors split the dataset in train (80%) and test (20%).

The neural network model used in this experiment comprised four linear layers, where each layer is followed by a ReLU as activation function. Before the fourth layer, a normalization was applied (under [symbol] ²-norm). During the embedding space transformation mode, the last layer was not applied in order to capture the new embedding space. To use the instructions as input to the model, the inventors used the all-minilm model (see [2]), which maps sentences to a 384-dimensional dense vector space, as initial embedder. See Appendix B.

### E.1 Evaluation

The inventors divided their evaluation into four different analysis, discussed in turn below:
Analysis I: Similarity between samples of the same class
Analysis II: Similarity between samples of different classes
Analysis III: Zero-shot comparison
Analysis IV: Embeddings visualization

### E.1.1 ANALYSIS I: SIMILARITY BETWEEN SAMPLES OF THE SAME CLASS

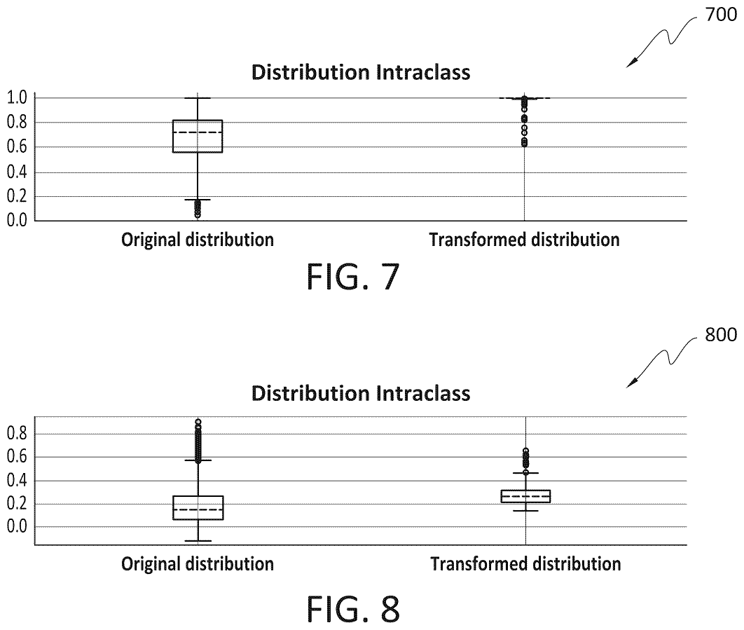

In the first evaluation scenario, the inventors analyzed the similarity score between samples from the same class, with the goal of demonstrating that an embodiment is capable of maintaining the similarity score higher for samples from the same task. To do that, the inventors applied the trained model without the last layer to generate the embeddings for the test set. Next, the cosine similarity was calculated between all samples from the same class, a transformed distribution. In order to compare our solution with a baseline, we create the same experiment using the all-minilm model as embedder, the original distribution, and calculating the cosine similarity. Here, reference is made to the graph 700 disclosed in FIG. 7 which discloses cosine similarity using all samples—minilm (“original distribution” in FIG. 7) and an embodiment (“transformed distribution” in FIG. 7) for the same class (values closer to 1 are better). FIG. 7 shows that, even for outliers, the similarity between samples from the same class—that is, on an intraclass basis—is higher than 0.5. On the other hand, in the original distribution, the similarities may vary more widely, between 0 and 1. Please refer to Appendix B for results for each task individually.

### E.1.2 Analysis II: Similarity Between Samples of Different Classes

In the second evaluation scenario, the inventors analyzed the similarity score between samples from different classes, with the goal of demonstrating that an embodiment is capable of maintaining a small similarity score for samples from the different tasks. To do that, the inventors applied the same experiment from the Analysis I but calculating the cosine similarities between samples from different classes. The inventors also compared our results using all-minilm as a baseline embedder. Considering the original distribution, shown in FIG. 8, the similarities scores may also vary between 0 and 1. Particularly, the graph 800 disclosed in FIG. 8 discloses cosine similarity—on an interclass basis—using all-minilm (original distribution) and the proposed solution (transformed distribution) for samples in different classes (values closer to 0 are better).

Although there are some outliers, most of the scores for the transformed distribution are smaller than 0.5. The results in Analysis I and Analysis II demonstrate that the transformed distribution is better to distinguish if samples are from the same task or not by easily defining a threshold. Please refer to Appendix B for results for each task individually.

### E.1.3 Analysis III: Zero-Shot Comparison

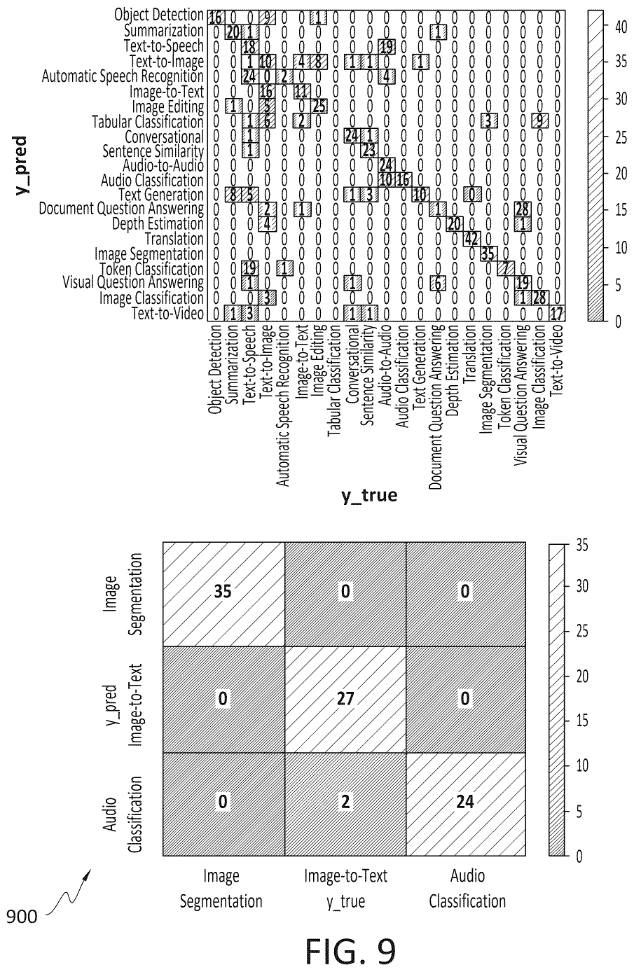

To compare the experimental results with a baseline, the inventors applied a zero-shot classifier in our test set. The inventors selected bart-large-mnli (see [8] which receives a text and a list of possible class names as input, and returns as output the class, tasks for example, with higher probability. The performance of zero-shot classifiers typically decreases as the number of classes is increased. FIG. 9 discloses confusion matrices 900 that summarize the classification capabilities of this zero-shot classifier for only three classes (randomly selected) and for all the available classes in the dataset.

In more detail, FIG. 9 discloses confusion matrices summarizing the results of applying the bart-large-mnli zero-shot classifier in a test set. The left portion of FIG. 9 corresponds to applying the image in a small subset of the available classes. The right portion of FIG. 9 corresponds to using the model for all the available classes, considerably impacting the classification quality.

As expected, while this model presents a good performance when considering only a small subset of classes, the model quality decays considerably as the number of classes increases. Although most samples were correctly classified, the model was not able to understand and classify some tasks. For instance, 28 samples from the task Visual Question Answering were classified as Document Question Answering, and 19 samples from Audio-to-audio were classified as Text-to-speech.

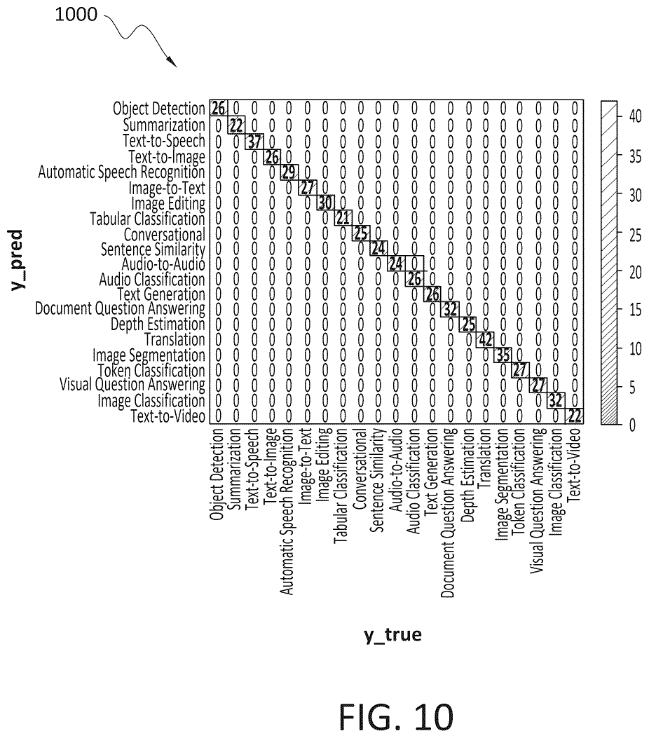

On the other hand, an approach according to one embodiment was able to correctly classify almost all samples from all tasks, even for a large number of classes. A confusion matrix 1000 corresponding to this embodiment is shown in FIG. 10. Particularly, FIG. 10 discloses a confusion matrix 1000 applying one example embodiment as a classifier in the test set.

### E.1.4 Analysis IV: Embeddings Visualization

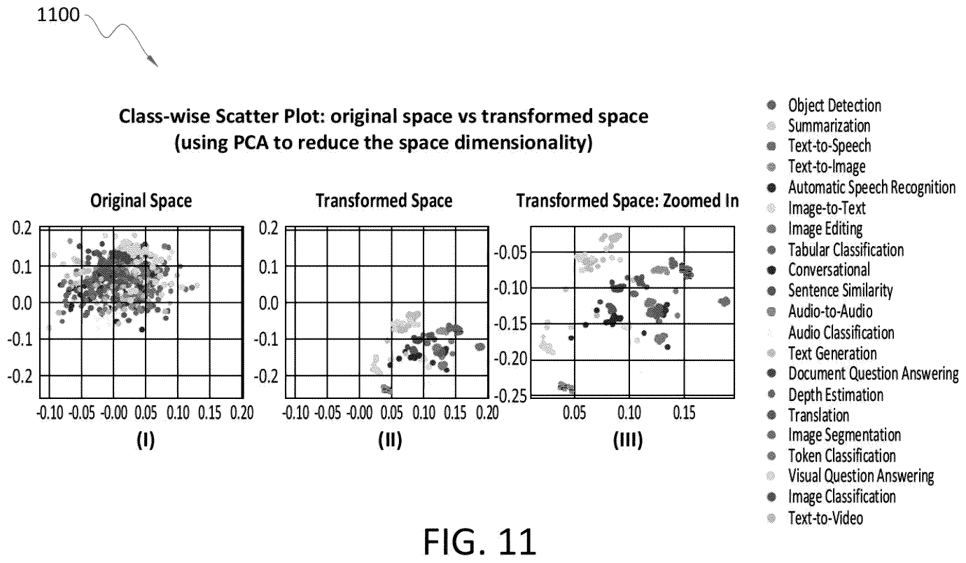

For the last scenario, the inventors applied the Principal Component Analysis (PCA) to reduce the embeddings to two dimensions and plotted the result, as shown in the class-wise scatter plot 1100 disclosed in FIG. 11. Considering the original space (1), there is no pattern for samples from the same task. On the contrary, in the transformed space (11), the samples from the same task are closer to each other, resulting in a clearer division between tasks (111). In this way, one or more embodiments are able to maintain the similarity score lower for samples from different tasks and higher for samples from the same task. In practical terms, methods according to one or more embodiments enhance the separability between embeddings from different classes.

### F. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. FURTHER EXAMPLE EMBODIMENTS

Following are some further example embodiments. These are presented only by way of example and are not intended to limit the scope of this disclosure or the claims in any way.

Embodiment 1. A method, comprising: A method for facilitating the orchestration of tasks that are based on user inputs provided to an LLM (large language model), comprising: receiving, by an embedding space transformation module, respective inputs from a first user and a second user; creating, by the embedding space transformation module, respective embedding vectors for each of the inputs; by the embedding space transformation module, transforming the embedding vectors into respective transformed embedding vectors; performing, by a cosine similarity function, a comparison of the transformed embedding vectors; outputting, by the cosine similarity function, a similarity score based on the comparison that indicates an extent to which the inputs are similar to each other; and, calling, by an orchestrator, one or more tasks whose type and number are determined based in part on the similarity score.

Embodiment 2. The method as recited in any preceding embodiment, wherein the embedding space transformation module is an element of a neural network that also includes a classification module that is employed only for training the embedding space transformation module.

Embodiment 3. The method as recited in any preceding embodiment, wherein the embedding space transformation module was trained prior to receipt of the inputs.

Embodiment 4. The method as recited in any preceding embodiment, wherein either: the inputs are identified as being from same respective tasks even if descriptions of the inputs are different; or the inputs are identified as being from different tasks even if the descriptions of the inputs are similar.

Embodiment 5. The method as recited in any preceding embodiment, wherein the embedding space transformation module is an element of a neural network that is embedded in a Euclidean space.

Embodiment 6. The method as recited in any preceding embodiment, wherein the embedding space transformation module is an element of a neural network comprising a multi-layer perceptron configured to perform classification tasks concerning the inputs.

Embodiment 7. The method as recited in any preceding embodiment, wherein the embedding space transformation module is an element of a neural network that also includes a classification module that was trained simultaneously with the embedding space transformation module.

Embodiment 8. The method as recited in any preceding embodiment, wherein transforming the embedding vectors into respective transformed embedding vectors comprises using a function of the embedding space transformation module to map a vector embedding space of the embedding vectors into another vector embedding space, corresponding to the transformed embedding vectors, having a different metric and a same dimensionality as the vector embedding space.

Embodiment 9. The method as recited in any preceding embodiment, wherein the transforming of the embedding vectors into respective transformed embedding vectors is performed without requiring retraining of the embedding space transformation module.

Embodiment 10. A system, comprising hardware and/or software, operable to perform any of the operations, methods, or processes, or any portion of any of these, disclosed herein.

Embodiment 11. A non-transitory storage medium having stored therein instructions that are executable by one or more hardware processors to perform operations comprising the operations of any one or more of embodiments 1-9.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

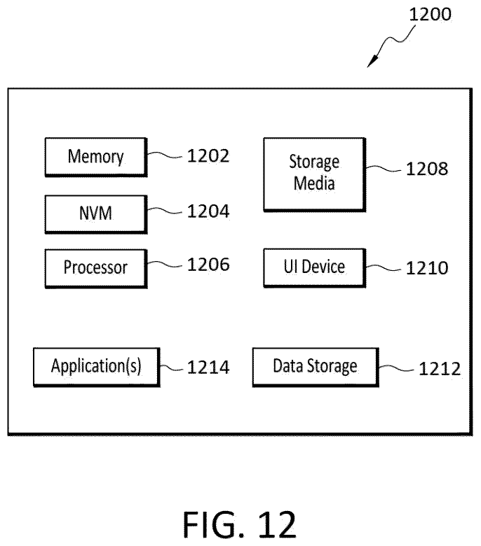

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for facilitating the orchestration of tasks that are based on user inputs provided to an LLM (large language model), comprising:
receiving, by an embedding space transformation module, respective inputs from a first user and a second user;
creating, by the embedding space transformation module, respective embedding vectors for each of the inputs;
by the embedding space transformation module, transforming the embedding vectors into respective transformed embedding vectors;
performing, by a cosine similarity function, a comparison of the transformed embedding vectors;
outputting, by the cosine similarity function, a similarity score based on the comparison that indicates an extent to which the inputs are similar to each other; and
calling, by an orchestrator, one or more tasks whose type and number are determined based in part on the similarity score.

2. The method as recited in claim 1, wherein the embedding space transformation module is an element of a neural network that also includes a classification module that is employed only for training the embedding space transformation module.

3. The method as recited in claim 1, wherein the embedding space transformation module was trained prior to receipt of the inputs.

4. The method as recited in claim 1, wherein either: the inputs are identified as being from same respective tasks even if descriptions of the inputs are different; or the inputs are identified as being from different tasks even if the descriptions of the inputs are similar.

5. The method as recited in claim 1, wherein the embedding space transformation module is an element of a neural network that is embedded in a Euclidean space.

6. The method as recited in claim 1, wherein the embedding space transformation module is an element of a neural network comprising a multi-layer perceptron configured to perform classification tasks concerning the inputs.

7. The method as recited in claim 1, wherein the embedding space transformation module is an element of a neural network that also includes a classification module that was trained simultaneously with the embedding space transformation module.

8. The method as recited in claim 1, wherein transforming the embedding vectors into respective transformed embedding vectors comprises using a function of the embedding space transformation module to map a vector embedding space of the embedding vectors into another vector embedding space, corresponding to the transformed embedding vectors, having a different metric and a same dimensionality as the vector embedding space.

9. The method as recited in claim 1, wherein the transforming of the embedding vectors into respective transformed embedding vectors is performed without requiring retraining of the embedding space transformation module.

10. A non-transitory storage medium having stored therein instructions that are executable by one or more hardware processors to implement a method for facilitating the orchestration of tasks that are based on user inputs provided to an LLM (large language model), by performing operations comprising:
receiving, by an embedding space transformation module, respective inputs from a first user and a second user;
creating, by the embedding space transformation module, respective embedding vectors for each of the inputs;
by the embedding space transformation module, transforming the embedding vectors into respective transformed embedding vectors;
performing, by a cosine similarity function, a comparison of the transformed embedding vectors;
outputting, by the cosine similarity function, a similarity score based on the comparison that indicates an extent to which the inputs are similar to each other; and
calling, by an orchestrator, one or more tasks whose type and number are determined based in part on the similarity score.

11. The non-transitory storage medium as recited in claim 10, wherein the embedding space transformation module is an element of a neural network that also includes a classification module that is employed only for training the embedding space transformation module.

12. The non-transitory storage medium as recited in claim 10, wherein the embedding space transformation module was trained prior to receipt of the inputs.

13. The non-transitory storage medium as recited in claim 10, wherein either: the inputs are identified as being from same respective tasks even if descriptions of the inputs are different; or the inputs are identified as being from different tasks even if the descriptions of the inputs are similar.

14. The non-transitory storage medium as recited in claim 10, wherein the embedding space transformation module is an element of a neural network that is embedded in a Euclidean space.

15. The non-transitory storage medium as recited in claim 10, wherein the embedding space transformation module is an element of a neural network comprising a multi-layer perceptron configured to perform classification tasks concerning the inputs.

16. The non-transitory storage medium as recited in claim 10, wherein the embedding space transformation module is an element of a neural network that also includes a classification module that was trained simultaneously with the embedding space transformation module.

17. The non-transitory storage medium as recited in claim 10, wherein transforming the embedding vectors into respective transformed embedding vectors comprises using a function of the embedding space transformation module to map a vector embedding space of the embedding vectors into another vector embedding space, corresponding to the transformed embedding vectors, having a different metric and a same dimensionality as the vector embedding space.

18. The non-transitory storage medium as recited in claim 10, wherein the transforming of the embedding vectors into respective transformed embedding vectors is performed without requiring retraining of the embedding space transformation module.
